(19) United States
(12) Patent Application Publication
(10) Pub. No.: US 2013/0032436 A1
(43) Pub. Date: Feb. 7, 2013

(54) HYDRAULIC BRAKING DEVICE FOR A YAW DRIVE OF A WIND TURBINE AND CONTROL DEVICE THEREFOR

(71) Applicants: Peter Boehm, Unna (DE); Patrice Devoulon, Domont (FR)

(72) Inventors: Peter Boehm, Unna (DE); Patrice Devoulon, Domont (FR)

(21) Appl. No.: 13/574,072

(22) PCT Filed: Mar. 29, 2010
(86) PCT No.: PCT/EP2010/001971

§ 371 Date: Oct. 19, 2012

(30) Foreign Application Priority Data
Jan. 20, 2010 (DE) 10 2010 006 299.5

(51) Int. Cl. F03D 11/00; B60T 8/00; F16D 55/22

(52) U.S. Cl. 188/72.1; 188/73.1; 188/151 R

(57) ABSTRACT

The invention relates to a hydraulic braking device for a yaw drive of a wind turbine and to a control device therefor. A hydraulic braking device for a yaw drive in a nacelle of a wind turbine, comprising a brake disk ring rotationally fixed to the nacelle, a plurality of disk brakes distributed over the circumference of the brake disk ring being associated with the brake disk ring, is known. According to the invention, at least one disk brake is provided with a friction lining arrangement that differs from the other disk brakes, the friction coefficient of said friction lining arrangement being reduced compared to the other disk brakes. The invention can be used for wind turbines.

Hydraulic braking device for a yaw drive of a wind turbine and control device therefor

The invention relates to a hydraulic braking device for a yaw drive of a nacelle of a wind turbine, with a brake disk ring which is rotationally fixed to the nacelle and to which is assigned, distributed over its circumference, a multiplicity of disk brakes, and also to a control device for activating a hydraulic braking device of this type and to a method for controlling a hydraulic braking device of this type.

Hydraulic braking devices of this type for yaw drives of wind turbines are generally known. A wind turbine of this type has a tower which stands firmly on ground and at the tip of which a nacelle supporting a wind rotor is mounted rotatably in the horizontal direction. A yaw drive is provided for rotating the nacelle with respect to the stationary tower. In order to lock the nacelle in a set rotary position, for example in the wind direction, a hydraulic braking device is provided. The hydraulic braking device also serves for building up a controlled braking action during a rotational movement of the nacelle. The braking device has a brake disk ring which is fixed rotationally to the nacelle and which is horizontally oriented coaxially to an axis of rotation of the nacelle and has a relatively large diameter. Provided, distributed over the circumference of the brake disk ring, is a plurality of disk brakes which engage in a pincer-like manner around a corresponding disk portion of the brake disk ring and which are fastened stationarily to the tower via a carrier arrangement. Preferably, more than ten disk brakes are arranged, distributed over the circumference of the brake disk ring. So that the nacelle can be locked in the set wind direction, all the disk brakes are acted upon simultaneously with a brake pressure of about 170 bar. This constitutes the holding mode of the braking device. In order to allow the nacelle to rotate in a rotation mode and nevertheless exert a controlled braking action upon the brake disk ring and consequently upon the nacelle, the disk brakes are operated with a reduced pressure of about 10 bar in the rotation mode. Consequently, even in the rotation mode, all the friction linings of the disk brakes bear with a certain pressure against the brake disk ring. This may give rise to creaking and friction noises which may cause some annoyance in the surroundings of the wind turbine.

The object of the invention is to provide a braking device, a control device and a method of the type initially mentioned which at least largely reduce disturbing noises when the nacelle is in the rotation mode.

This object is achieved, for the hydraulic braking device, in that at least one disk brake is provided with a friction lining arrangement which is different from the other disk brakes and the coefficient of friction of which is reduced with respect to the other disk brakes. The solution according to the invention is based on the fact that friction lining arrangements having a reduced coefficient of friction give rise at most to insignificant noises during a sliding action of the brake disk ring.

In an embodiment of the invention, the at least one disk brake having a different friction lining arrangement has at least one releasable housing side cheek which, in the released state, enables the friction lining arrangement to be removed laterally. The braking device according to the invention consequently has differently configured disk brakes. At least one disk brake is configured in such a way that it is possible for the friction lining arrangement to be removed laterally. The advantage of this is that corresponding friction linings can be changed, without the corresponding disk brake having to be released from its position on the brake disk ring. The arrangement of the disk brake merely has to be such that sufficient space for removing the friction lining arrangement and for inserting a new friction lining arrangement is available laterally next to the disk brake, that is to say in the circumferential direction of the brake disk ring for the nacelle.

For the control device for activating a hydraulic braking device both for a holding mode and for a rotation mode of the nacelle, the object on which the invention is based is achieved in that, in the holding mode, all the disk brakes are controlled at holding pressure, and in that, in the rotation mode of the nacelle, a brake pressure is generated by a reduced number of disk brakes controlled at holding pressure, and in that the remaining disk brakes are controlled pressurelessly. The reduced number of disk brakes is dependent on the overall number of disk brakes which are used, and when the nacelle is in the rotation mode the brake pressure is generated by at least one individual disk brake which is controlled at holding pressure. Preferably, two disk brakes which are controlled at holding pressure are provided when the nacelle is in the rotation mode. The advantageous number of two disk brakes which are controlled at holding pressure in the rotation mode is combined with preferably twelve further disk brakes which are controlled pressurelessly. The holding pressure is a defined pressure which is identical for all the disk brakes. Advantageously, the number of disk brakes which are controlled at holding pressure is lower than the number of disk brakes which are controlled pressurelessly in the rotation mode. Instead of pressureless control, that is to say control at zero, it is also possible to act upon these disk brakes with a pressure which is greatly reduced with respect to the holding pressure.

In an embodiment of the invention, the at least one disk brake which is controlled at holding pressure in the rotation mode has a friction lining arrangement with a coefficient of friction which is reduced with respect to the pressurelessly controlled disk brakes. A further-improved noise reduction is thereby achieved in the rotation mode, for since only a small number of disk brakes are acted upon with pressure in the rotation mode, the number of surfaces sliding with pressure on the brake disk ring is already necessarily reduced. For only the pressure-loaded disk brakes bear firmly with their friction lining arrangements against the corresponding surfaces of the brake disk ring. The generation of noise caused by sliding friction is further reduced by the choice of friction lining arrangements having a reduced coefficient of friction.

In a further embodiment of the invention, the holding pressure of the disk brakes in the rotation mode and in the holding mode lies in the range of between 120 and 200 bar. Especially advantageously, all the disk brakes either are activated with the maximum holding pressure of between 120 and 200 bar or are switched to pressureless. Control to reduced brake pressures is not necessary, but is possible according to other embodiments. According to the invention, the required reduced brake pressure in the rotation mode is achieved in that only a small number of disk brakes, but at least one disk brake, is still acted upon with the holding pressure, whereas the other disk brakes are switched to pressureless. Hydraulic switching can consequently be built up by means of extremely simple control components.

In a further embodiment of the invention, all the disk brakes are connected to a common hydraulic circuit, and a connecting line of the at least one disk brake controlled at holding pressure in the rotation mode is assigned a hydraulic shut-off element, in particular a nonreturn valve, controllable as a function of pressure. Especially advantageously, for the at least one disk brake, a nonreturn valve is provided which, during a corresponding operation to ventilate the hydraulic control, prevents pressure release in the region of the at least one disk brake in that the nonreturn valve closes the corresponding connecting line.

For the method of controlling a hydraulic braking device, all the disk brakes being controlled at a holding pressure in a holding mode and a reduced brake pressure being exerted upon the brake disk ring in a rotation mode, the object on which the invention is based is achieved in that, in the rotation mode, at least one disk brake is controlled at full holding pressure and the remaining disk brakes are controlled pressurelessly. As a result, overall, the desired reduced brake pressure is exerted on the brake disk ring by the disk brakes. The advantage of noise reduction is combined with the possibility of hydraulic switching which can be built up in a simple way.

Further advantages and features of the invention can be gathered from the claims and from the following description of a preferred embodiment of the invention which is illustrated by means of the drawings.

FIG. 1 shows diagrammatically, in a partially cut-away illustration, an embodiment of a wind turbine in the region of a rotatable nacelle with a hydraulic braking device,

FIG. 2 shows, in an enlarged diagrammatic illustration, a top view of the hydraulic braking device for the nacelle according to FIG. 1,

FIG. 3 shows, in a further-enlarged illustration, a detail III of the braking device according to FIG. 2,

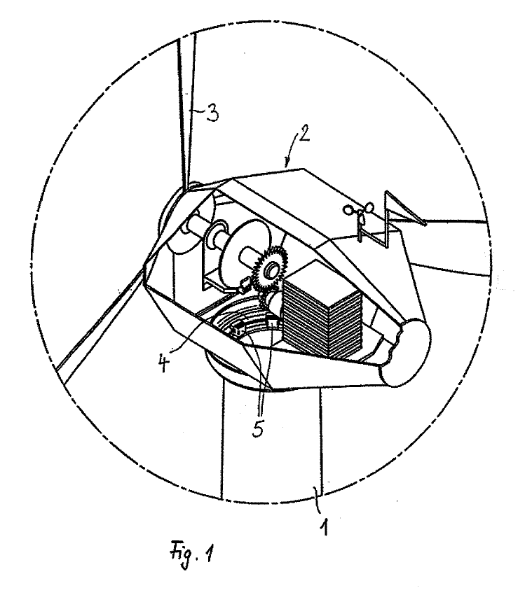

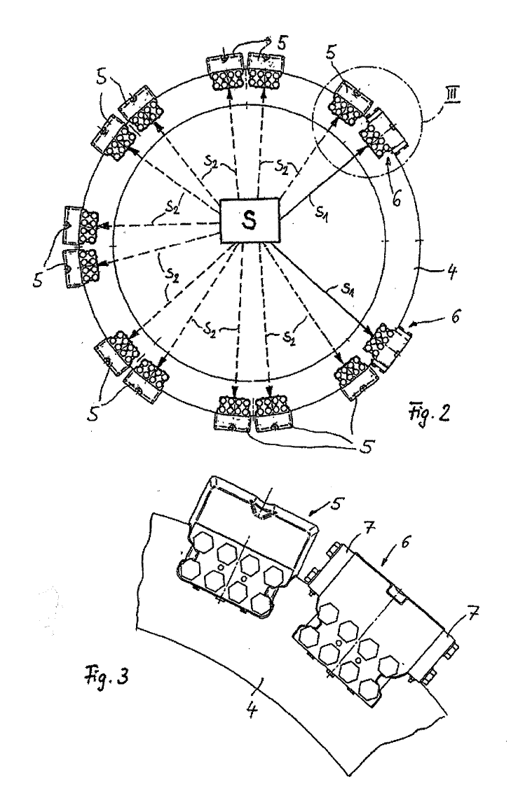

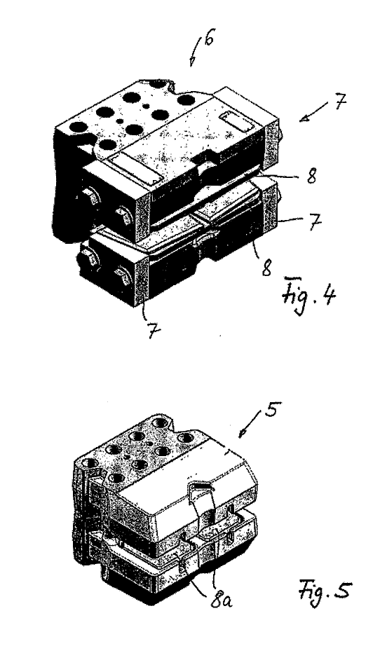

FIG. 4 shows, in an enlarged perspective illustration, a first type of disk brakes used in the braking device according to FIG. 2, and

FIG. 5 shows a second type of disk brakes used in the braking device according to FIG. 2.

A wind turbine has according to FIG. 1 a tower 1 which is founded on firm ground and which carries a nacelle 2 in the region of its tip. The nacelle 2 is mounted rotatably about a vertical axis of rotation in relation to the tower 1 in the horizontal direction. The nacelle carries a wind rotor 3 which in the basically known way is set in rotation by wind and serves for generating power by means of a generator. So that the nacelle 2 can be rotated, a yaw drive is provided in a way not illustrated in any more detail. So that the nacelle 2 can be locked in a desired rotary position and in order to exert a controlled braking action upon the nacelle 2 when the nacelle 2 is rotated by means of the yaw drive, a braking device is provided which is described in more detail with reference to FIGS. 2 to 5.

The braking device has a brake disk ring 4 which is connected fixedly in terms of rotation to the nacelle and which is oriented in relation to the tower 1 coaxially to the axis of rotation of the nacelle 2. The brake disk ring 4 is assigned a plurality of disk brakes 5, 6 which are arranged in a manner distributed over the circumference of the brake disk ring 4. As can be seen from FIG. 2, overall fourteen disk brakes 5, 6 are provided which are assigned to one another in pairs. All the disk brakes 5, 6 have a pincer-like brake housing which engages around the brake disk ring 4 in the region of the topside and underside of the latter. On each of the two sides of the brake disk ring 4, each disk brake 5, 6 has at least one brake piston and one friction lining arrangement 8, 8a. The friction lining arrangements 8 and 8a of the disk brake 5, 6 can therefore be pressed from above and pulled from below against the corresponding surface portions of the brake disk ring 4 when the brake pistons are acted upon correspondingly with pressure. All the disk brakes 5, 6 are designed as hydraulic disk brakes. The corresponding brake pistons are acted upon hydraulically with pressure or are switched to pressureless.

To activate the disk brakes 5 and 6 hydraulically, a hydraulic control unit S is provided which activates the corresponding brake pistons of the disk brakes 5 and 6 via hydraulic lines s₁, s₂.

As can be seen from FIGS. 2 and 3, the hydraulic braking device has two different types of disk brakes 5 and 6. Overall twelve disk brakes 5 according to FIG. 5 and two disk brakes 6 according to FIG. 4 are provided. In the case of the disk brakes 5, the friction lining arrangements 8a can be released from the brake housing only upward or downward. In the case of the disk brakes 6 according to FIGS. 2 to 4, however, the brake housing has on opposite sides in each case two removable housing side cheeks 7 both for the upper brake pincer portion and for the lower brake pincer portion. The housing side cheeks 7 are connected by means of screw connections to the corresponding housing portions of the brake housing. After removal of a corresponding housing side cheek portion 7, it is possible to remove the respective friction lining arrangement 8 laterally and insert a new friction lining arrangement 8 from the side. The great advantage of this is that exchange of the friction lining arrangements 8 can take place when the respective disk brake 6 is in the mounted state on the brake disk ring 4. By contrast, exchange of the friction lining arrangements 8a of each disk brake 5 is possible only after the corresponding demounting and removal of the respective disk brake 5 from the brake disk ring 4.

In the exemplary embodiment illustrated, the friction lining arrangements 8 of the two disk brakes 6 have a reduced coefficient of friction with respect to the friction lining arrangements 8a of the disk brakes 5.

When the wind turbine is in operation, the braking device is controlled as follows:

In a holding mode in which the nacelle 2 is already oriented in the desired wind direction and is to be detained in this oriented rotary position, all the disk brakes 5 and 6 are acted upon with a brake pressure (holding pressure) in each case of between 170 and 180 bar.

As soon as the nacelle 2 is to be rotated, the twelve disk brakes 5 are switched to pressureless. By contrast, the two disk brakes 6 continue to be acted upon with the brake pressure of about 170 to 180 bar. Since at the same time the friction lining arrangement 8 of the two disk brakes 6 has a reduced coefficient of friction, in this rotation mode the brake pressure of the two disk brakes 6 is not sufficient to lock the brake disk ring 4. Instead, the brake pressure of the two disk brakes 6 brings about only the desired controlled braking action upon the brake disk ring 4, in order, during the rotation of the nacelle, to apply sufficient torque which prevents an undesirable oscillating movement on a gear of the yaw drive. The friction lining arrangements 8 of the two disk brakes 6 become worn relatively quickly as a result of this “sliding braking”. However, since the disk brakes 6 do not have to be demounted in order to exchange the friction lining arrangements 8, it is possible to exchange the friction lining arrangements 8 quickly. Moreover, only the friction lining arrangements 8 of the two disk brakes 6 become worn, whereas the remaining twelve disk brakes have virtually no wear of their friction lining arrangements 8a, since they apply the desired holding pressure essentially when the nacelle 2 is in the static state.

As can be seen from FIG. 2, the two pairs of disk brakes 5, 6 which in each case comprise a disk brake 6 with laterally exchangeable friction lining arrangements 8 are arranged adjacently to one another along the brake disk ring 4, there being a greater distance between these two pairs of disk brakes 5, 6 than between the remaining pairs of disk brakes 5. Moreover, the two disk brakes 6 having the laterally exchangeable friction lining arrangements 8 are arranged on the mutually confronting sides of the two pairs of disk brakes, so that the greater distance between the pairs of disk brakes 5, 6 can be utilized for both disk brakes 6 in order to carry out the demounting of the housing side cheeks 7 and the exchange of the friction lining arrangements 8.

Thus, by virtue of the embodiment according to the invention, two different hydraulic activation means are provided for a holding mode of the nacelle 2, on the one hand, and for a rotation mode of the nacelle 2, on the other hand. In the holding mode, all the disk brakes and 6 are acted upon with the corresponding maximum brake pressure. By contrast, in the rotation mode, the disk brakes 5 are ventilated and consequently are controlled pressurelessly. In the case of the disk brakes 6, however, the maximum brake pressure is maintained. According to an especially simple embodiment, nonreturn valves are provided in the region of the hydraulic lines s₁ of the disk brakes 6 and, when the overall hydraulic circuit is ventilated by means of the control unit S, are transferred into their shut-off position by the corresponding pressure drop, so that the desired brake pressure is maintained in both disk brakes 6. In order to switch also these disk brakes 6 to pressureless for the purpose of maintenance of the nacelle or the like, the nonreturn valves can be transferred into their open position again manually or by means of an additional control element.

1. A hydraulic braking device for a yaw drive of a nacelle of a wind turbine, with a brake disk ring which is rotationally fixed to the nacelle and to which is assigned, distributed over its circumference, a multiplicity of disk brakes, wherein at least one disk brake is provided with a friction lining arrangement which is different from the other disk brakes and the coefficient of friction of which is reduced with respect to the other disk brakes.

2. The braking device as claimed in claim 1, wherein the at least one disk brake having a different friction lining arrangement has at least one releasable housing side cheek which, in the released state, enables the friction lining arrangement to be removed laterally.

3. A control device for activating a hydraulic braking device according to claim 1, wherein in a holding mode of the nacelle, all the disk brakes are controlled at a holding pressure, and in that, in a rotation mode of the nacelle, a brake pressure is generated by a reduced number of disk brakes controlled at holding pressure, and in that the remaining disk brakes are controlled pressurelessly.

4. The control device as claimed in claim 3, wherein the at least one disk brake which is controlled at holding pressure in the rotation mode has a friction lining arrangement with a coefficient of friction which is reduced with respect to the pressurelessly controlled disk brakes.

5. The control device as claimed in claim 3, wherein the braking device has two disk brakes which are controlled at holding pressure in the rotation mode and twelve disk brakes which are controlled pressurelessly in the rotation mode.

6. The control device as claimed in claim 3, wherein the holding pressure of the disk brakes in the rotation mode and in the holding mode lies in the range of between 120 and 200 bar.

7. The control device as claimed in claim 3, wherein all the disk brakes are connected to a common hydraulic circuit, and in that a connecting line of the at least one disk brake controlled at holding pressure in the rotation mode is assigned a hydraulic shut-off element, in particular a nonreturn valve, controllable as a function of pressure.

8. A method for controlling a hydraulic braking device according to claim 1, all the disk brakes being controlled at a holding pressure in a holding mode, and a reduced brake pressure being exerted upon the brake disk ring in a rotation mode, wherein in the rotation mode, at least one disk brake is controlled at full holding pressure and the remaining disk brakes are controlled pressurelessly.

9. A control device for activating a hydraulic braking device for a yaw drive of a nacelle of a wind turbine, the hydraulic braking device having a brake disk ring which is rotationally fixed to the nacelle and to which is assigned, distributed over its circumference, a multiplicity of disk brakes, wherein in a holding mode of the nacelle, all the disk brakes are controlled at a holding pressure, and, in a rotation mode of the nacelle, a brake pressure is generated by a reduced number of disk brakes controlled at holding pressure, and the remaining disk brakes are controlled pressurelessly.

10. A method for controlling a hydraulic braking device for a yaw drive of a nacelle of a wind turbine, the hydraulic braking device having a brake disk ring which is rotationally fixed to the nacelle and to which is assigned, distributed over its circumference, a multiplicity of disk brakes, all the disk brakes being controlled at a holding pressure in a holding mode, and a reduced brake pressure being exerted upon the brake disk ring in a rotation mode, wherein in the rotation mode, at least one disk brake is controlled at full holding pressure and the remaining disk brakes are controlled pressurelessly.
